(19) United States
(12) Patent Application Publication
(10) Pub. No.: US 2023/0135828 A1
(43) Pub. Date: May 4, 2023

(54) PRESSURE CONTAINERS AND PRESSURE CONTAINER ASSORTMENT

(71) Applicant: Andreas Jahn, Tambach-Dietharz (DE)

(72) Inventor: Andreas Jahn, Tambach-Dietharz (DE)

(21) Appl. No.: 18/052,551

(22) Filed: Nov. 3, 2022

(30) Foreign Application Priority Data
Nov. 4, 2021 (DE) 102021128723.5

(51) Int. Cl. F17C 1/14

(52) U.S. Cl. CPC F17C 1/14; F17C 2270/0736; F17C 2205/05; F17C 2221/013; F17C 2203/0646; F17C 2203/0619; F17C 2201/0119; F17C 2201/032; F17C 2203/0648; F17C 2203/066

(57) ABSTRACT

The invention relates to a pressure container (2) provided for multiple filling with a medium for introduction into a beverage, wherein an outer side of the pressure container (2) is formed with a marking (F1, F2, F3) associated with the medium. Furthermore, the invention relates to an assortment of pressure containers (1).

### CROSS-REFERENCE TO RELATED APPLICATION

This application claims priority to German application no. DE 10 2021 128 723.5 filed on Nov. 4, 2021, which is hereby incorporated by reference in its entirety.

### FIELD OF INVENTION

The invention relates to a pressure container and an assortment of pressure containers.

### BACKGROUND

Pressure containers for filling with carbon dioxide for introduction into a beverage are generally known from the prior art. The pressure container filled with carbon dioxide is inserted into a device by means of which the carbon dioxide can be introduced into the beverage, for example water. Such a device is also referred to as a water bubbler or beverage bubbler.

### SUMMARY

The object of the invention is to specify a pressure container which is improved compared to the prior art and a pressure container assortment which is improved compared to the prior art.

According to the invention, the object is achieved by a pressure container and a pressure container assortment according to the appended set of claims.

Advantageous embodiments of the invention are the subject of the dependent claims.

A pressure container according to the invention, in particular a pressurised gas container, is provided for multiple filling, thus for refilling with a medium for introduction into a beverage.

The medium is in particular carbon dioxide, carbon dioxide produced in a predetermined manner or carbon dioxide with a flavour, i.e. carbon dioxide to which a flavour has been added. The first-mentioned carbon dioxide is, for example, neutral carbon dioxide, in particular carbon dioxide produced in a conventional manner and without any particular specifications. This means, for example, that it is produced in such a way that it is suitable for use for food and/or in food. Carbon dioxide produced in a specified manner is, for example, organic carbon dioxide, which is produced in a biological manner and/or according to corresponding organic specifications, kosher carbon dioxide or halal carbon dioxide, which is produced according to corresponding regulations.

If the medium contains carbon dioxide and a flavour, these components of the medium, i.e. the carbon dioxide and the flavour, can, for example, already be mixed before filling the pressure container and be filled together into the pressure container, or they can, for example, only come together in the pressure container. This means that the pressure container can also be filled with these two components of the medium one after the other, for example first with the flavour and then with the carbon dioxide. The medium with which the pressure container is then filled and which is then intended for introduction into a beverage then has the carbon dioxide and the flavour.

Once the pressure container is filled with the respective medium, it can be inserted into a device by means of which the medium, in particular the respective carbon dioxide and the flavour, if the medium has the flavour, can be introduced into the beverage, for example water. The device is therefore also called a water bubbler or beverage bubbler, whereby when the pressure container is filled with a medium containing a flavour, the flavour is also introduced into the beverage, for example water, and thus gives the water a taste corresponding to the flavour.

The problem here is that after the initial filling with the medium, the pressure container is contaminated by this medium, for example by the flavour of the medium or by the carbon dioxide produced in the respective way, and therefore cannot be used as desired, i.e. not with another medium, in particular not with carbon dioxide produced in a different way or a different flavour, as otherwise an unintended mixing of the media would occur, so that, for example, the regulations regarding organic, kosher or halal would no longer be fulfilled or different flavours would mix and thus an unintended taste of the beverage would occur. It is therefore necessary to refill the pressure container with the medium for which the pressure container is intended. In the prior art, the pressure container is therefore not refilled after initial filling and emptying, but disposed of if it is not clear with which medium it was filled, i.e. for which medium it is intended, because in such a case, time-consuming cleaning of the pressure container would be necessary before refilling it, which would cause considerably higher costs than a new, still unused pressure container.

In order to ensure that the pressure container can be refilled with the medium for which it is intended, thus avoiding the unsustainable disposal of the pressure container after it has been filled once, it is provided that an outer side of the pressure container is provided with a marking associated with the medium, in particular with a coloured marking associated with the medium. Thus, a unique identification, in particular identification colour, is assigned to each medium which is intended for filling such pressure containers, for example, a unique identification, in particular a unique identification colour, is assigned to the neutral carbon dioxide, the halal carbon dioxide, the kosher carbon dioxide, the organic carbon dioxide and the carbon dioxide with the respective flavour. The outside of the pressure container is thus provided with the unique identification, in particular the identification colour, of the medium for which it is intended to be filled several times.

This avoids confusion of pressure containers to be filled and media intended for the pressure containers when refilling the respective pressure container. The clearly marked outside of the pressure container, for example the coloured outside, also ensures that this marking of the pressure container and thus the assignment of the pressure container to the medium for which it is intended is reliably retained, even after multiple use and refilling.

In other embodiments, other forms of marking are also possible as an alternative to the design of the marking as an identification colour. The outside of the pressure container is then provided with such a marking associated with the medium.

In one possible embodiment, the pressure container is made of aluminium or an aluminium alloy. This enables a low weight of the pressure container. In addition, this makes it possible to anodise the pressure container, in particular the outside of the pressure container, in a particularly advantageous manner In a possible embodiment, it is provided that the outside is anodised in colour with the identification colour assigned to the medium, i.e. the outside of the pressure container is coloured by this coloured anodising with the identification colour assigned to the medium. This ensures a particularly good and long-lasting durability of the marking colour of the pressure container. In this embodiment, the outside of the pressure container is thus anodised in the colour of the identification colour assigned to the medium for which the pressure container is intended to be filled several times.

In one possible embodiment, the pressure container also has a transparent envelope on its outside with an identification label assigned to the medium. In this way, it is also apparent to persons who do not know the assignment of the marking to the medium, with which medium the pressure container is filled. The envelope is made of plastic, for example. In particular, it lies against the outside of the pressure container and is connected to the outside of the pressure container, in particular by a material bond, a form fit and/or a force fit, for example by shrinking on and/or gluing on or by producing the envelope on the outside of the pressure container as a coating. For example, the envelope is formed as a shrink film.

Due to the described solution, even if this labelled envelope is removed, for example after a respective use of the pressure container, the marked design, for example coloured design, of the outside of the pressure container with the marking, for example marking colour, assigned to the medium, the assignment of the pressure container to the medium for which it is intended and thus the refilling of the pressure container with the intended medium is still ensured.

The marked, for example coloured, in particular coloured anodised, design of the outside of the pressure container, in particular in conjunction with the in particular transparent envelope, also achieves an aesthetic appearance of the pressure container.

A pressure container assortment according to the invention, i.e. a pressure container set or pressure container set, has a plurality of such pressure containers, the outer sides of which are differently marked, in particular differently coloured, according to the respective medium for which the respective pressure container is intended. I.e. the pressure container assortment has pressure containers for different media, i.e. pressure containers which are provided for filling with different media, for example one or more pressure containers which are provided for filling with neutral carbon dioxide, and/or one or more pressure containers which are provided for filling with organic carbon dioxide, and/or one or more pressure containers which are provided for filling with halal carbon dioxide, and/or one or more pressure containers intended to be filled with kosher carbon dioxide, and/or one or more pressure containers intended to be filled with carbon dioxide and a flavour, and/or one or more pressure containers intended to be filled with carbon dioxide and a different flavour, respectively. Therefore, the outer sides of the pressure containers are formed with different markings, for example with different marking colours, i.e. different colours, because the outer side of the respective pressure container is formed with the marking associated with the respective medium for the filling of which the respective pressure container is provided, in particular the marking colour is formed in colour.

As described above, in a possible embodiment the respective pressure container is made of aluminium or an aluminium alloy and in a possible embodiment it is provided that the outside of the respective pressure container is anodised in colour with the identification colour assigned to the medium for the filling of which the respective pressure container is provided, i.e. the outside of the respective pressure container is formed in colour by this coloured anodising with the identification colour assigned to the medium.

As described above, in a possible embodiment, the respective pressure container additionally has the envelope, in particular transparent envelope, arranged on its outside with the identification labelling assigned to the medium. The envelope is made of plastic, for example. In particular, it is in contact with the outside of the respective pressure container and is connected to the outside of the respective pressure container, in particular, in a material-bond, form-fitting and/or force-fitting manner, for example, by shrinking on and/or gluing on or by producing the envelope on the outside of the respective pressure container as a coating. For example, the envelope is formed as a shrink film.

### BRIEF DESCRIPTION OF THE DRAWINGS

Examples of embodiments of the invention will be explained in more detail below with reference to a drawing.

FIG. 1 schematically shows an assortment of pressure containers.

### DETAILED DESCRIPTION OF SPECIFIC EMBODIMENTS

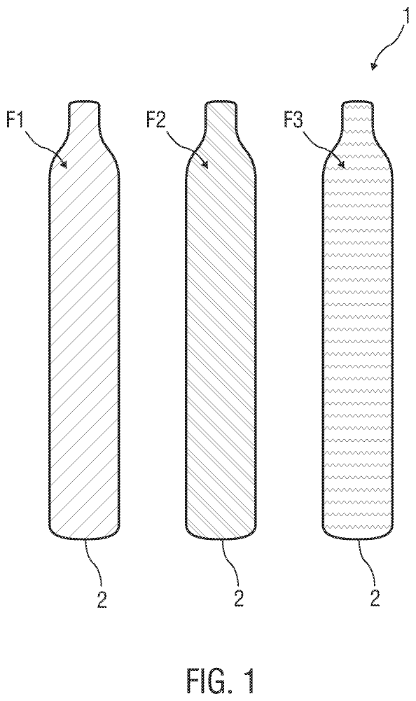

FIG. 1 shows a schematic representation of a pressure container assortment 1 with several pressure containers 2 in a side view. The pressure containers 2 are each intended for multiple filling with a medium for introduction into a beverage, whereby each of the pressure containers 2 is intended for filling with a different medium. I.e. the pressure container assortment 1 comprises pressure containers 2 for different media. Media for filling the pressure containers 2 are, for example, carbon dioxide and a respective flavour, neutral carbon dioxide, organic carbon dioxide, halal carbon dioxide and/or kosher carbon dioxide. For example, in the example shown, the pressure containers 2 are each provided for multiple filling with carbon dioxide and a flavour as a medium, with the flavours of the media for the pressure containers differing, i.e. each of the pressure containers 2 is provided for filling with a medium having a different flavour.

Once the respective pressure container 2 is filled with the respective medium, it can be inserted into a device by means of which the medium can be introduced into the beverage, for example water. The medium comprises in particular carbon dioxide, which is formed as described above or is mixed with a respective flavour. The device is therefore also referred to as a water bubbler or beverage bubbler. If the medium has carbon dioxide and a flavour, the flavour is also introduced into the beverage, for example water, due to the filling of the pressure container 2 with this medium and thus gives the water a taste corresponding to the flavour.

In order to ensure that the respective pressure container 2 can be refilled according to type with the medium for which the respective pressure container 2 is intended, it is provided that an outer side of the respective pressure container 2 is formed with an identification F1, F2, F3 associated with the medium for which it is intended, in particular with an identification colour associated with the medium for which it is intended. Since the pressure containers 2 of the pressure container assortment 1 are each intended for a different medium, their outer sides are thus differently marked according to the respective medium for which the respective pressure container 2 is intended, in the example shown differently coloured, schematically shown in FIG. 1 by different hatchings.

The respective pressure container 2 is in particular made of aluminium or an aluminium alloy. In particular, it is provided that the outside of the respective pressure container 2 is anodised in colour with the identification colour assigned to the medium for the filling of which the respective pressure container 2 is provided, i.e. the outside of the respective pressure container 2 is coloured by this coloured anodising with the identification colour assigned to the medium. In the example shown, the marking F1, F2, F3 is thus a marking colour produced by anodising.

For example, the respective pressure container 2 additionally has an envelope arranged on its outside, in particular a transparent envelope, with an identification marking assigned to the medium for whose filling the respective pressure container 2 is intended. The envelope is in particular made of plastic, in particular a shrink film.

### REFERENCE LIST

1 pressure container assortment

2 pressure container

F1, F2, F3 marking

What is claimed is:

1. A pressure container provided for multiple filling with a medium for introduction into a beverage, wherein an outer side of the pressure container is formed with a marking associated with the medium.

2. The pressure container according to claim 1, wherein the outside of the pressure container is coloured with a marking in the form of an identification colour.

3. The pressure container according to claim 1, wherein the pressure container is provided for multiple filling with one of a medium formed as carbon dioxide, a medium formed as carbon dioxide produced in a predetermined manner, and a medium formed as carbon dioxide and a flavour.

4. The pressure container according to claim 1, made of aluminium or an aluminium alloy.

5. The pressure container according to claim 4, wherein the outside is anodised in the colour of the identification colour associated with the medium.

6. The pressure container according to claim 1, comprising an envelope arranged on its outside with an identification labelling associated with the medium.

7. The pressure container according to claim 6, wherein the envelope is transparent.

8. The pressure container according to claim 6, wherein the envelope is made of plastic.

9. The pressure container according to claim 6, wherein the envelope is a shrink film.

10. An assortment of pressure containers, the assortment having a plurality of pressure containers according to claim 1, the outer sides of which are formed differently according to the respective medium for which the respective pressure container is intended.

11. The assortment according to claim 10, wherein the respective pressure container has an envelope arranged on its outside with an identification labelling associated with the medium.

12. The pressure container according to claim 2, wherein the pressure container is provided for multiple filling with one of a medium formed as carbon dioxide, a medium formed as carbon dioxide produced in a predetermined manner, and a medium formed as carbon dioxide and a flavour.
